(19) United States
(12) Patent Application Publication
(10) Pub. No.: US 2014/0380213 A1
(43) Pub. Date: Dec. 25, 2014

(54) LOCATION ADJUSTMENT SYSTEM AND RELATED METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YIN-ZHAN WANG, Shenzhen (CN)

(21) Appl. No.: 14/306,741

(22) Filed: Jun. 17, 2014

(30) Foreign Application Priority Data
Jun. 19, 2013 (CN) 2013102423203

(51) Int. Cl. G06F 3/0484; G06F 3/0481

(52) U.S. Cl. CPC G06F 3/0484; G06F 3/04817
USPC 715/765

(57) ABSTRACT

A location adjustment system with a floating icon displays a first region for displaying contents related to the applications and a second region for displaying the background picture. The location adjustment system comprises an obtaining module, a determining module, and an adjustment module. The obtaining module obtains first location information of the floating icon, a second location information of the first region, and a third location information of the second region based on the pixel coordinate. The determining module determines whether an overlapping area is existing between the first location information and the second location information. When an overlapping area is existing between the first location information and the second location information, the adjustment module adjusts the location of the floating icon.

### FIELD

The present disclosure relates to location adjustment systems, particularly to a location adjustment system for adjusting locations of floating icon.

### BACKGROUND

Electronic devices, such as mobile phones or tablet computers, include a plurality of floating icons displayed on a user interface.

### BRIEF DESCRIPTION OF THE FIGURES

Many aspects of the embodiments can be better understood with reference to the following drawings. The components in the drawings are not necessarily drawn to scale, the emphasis instead being placed upon clearly illustrating the principles of the testing system and testing method thereof Moreover, in the drawings, like reference numerals designate corresponding parts throughout the views.

FIG. 1 is a schematic diagram of an embodiment of an electronic device with a display and user interface with a floating icon.

FIG. 2 is a block diagram of an embodiment of the location adjustment system.

FIG. 3 is a schematic diagram of an embodiment of the electronic device in FIG. 1 while adjusting the location of the floating icon.

FIG. 4 is a schematic diagram of an embodiment of the electronic device in FIG. 1 while adjusting the first region adjacent to the preference region when the preference region is unable to receive the floating icon.

FIG. 5 is a schematic diagram of another embodiment of the electronic device in FIG. 1 while adjusting first region adjacent to the preference region when the preference region is unable to receive the floating icon.

FIG. 6 is a flowchart of the embodiment of the location adjusting method.

FIG. 7 is a flowchart detailing a step of adjusting the location of a floating icon from the method of FIG. 6 of an embodiment of the location adjusting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

In general, the word “module,” as used herein, can refer to logic embodied in hardware or firmware, or to a collection of software instructions, written in a programming language, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

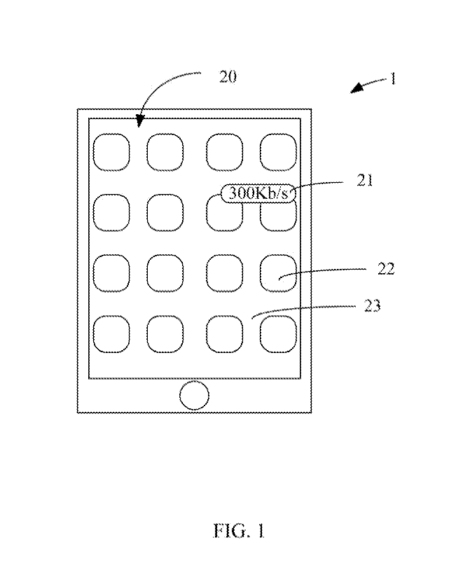

FIG. 1 illustrates an embodiment of an electronic device 1. The electronic device 1 displays a user interface 20 and a floating icon 21. The user interface 20 includes a first region 22 and a second region 23. In one embodiment, the electronic device 1 can be a computer, a tablet, or a personal digital assistant (PDA). The floating icon 21 is an indicator related to a download rate or a memory usage. The first region 22 is a display area for displaying contents related to applications, and the second region 23 is an external area beside the first region 22 for displaying background picture. There are no intersection between the first region 22 and the second region 23. The user interface 20 is composed of a plurality of pixels each corresponding to a pixel coordinates for specifically identifying locations.

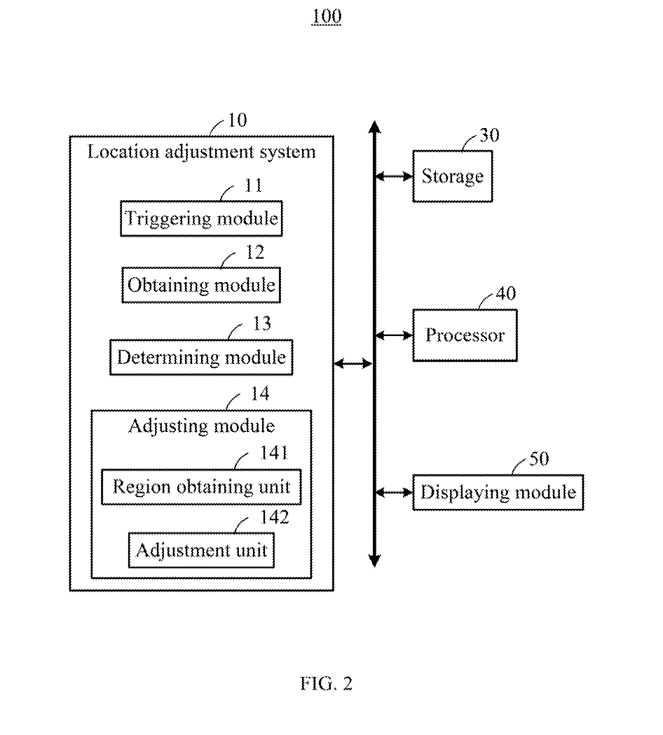

FIG. 2 shows a block diagram of an embodiment of the electronic device 1. The electronic device 1 includes a location adjustment system 10, a storage 30, a processor 40, and a display module 50.

The location adjustment system 10 includes a triggering module 11, a obtaining module 12, a determining module 13, and an adjustment module 14.

The triggering module 11 generates a trigger signal when being triggered.

The obtaining module 12 obtains first location information related to the floating icon 21, second location information related to the first region 22, and third location information related to the second region 23 based on the pixel coordinate in response to the trigger signal. The location information is a pixel coordinate assemblage.

The determining module 13 determines whether an overlapping area is existing between the first location information and the second location information. When an overlapping area is existing between the first location information and the second location information, the determining module 13 generates an adjustment signal. When no overlapping area is existing between the first location information and the second location information, the determining module 13 determines that there is no need for adjusting the location of the floating icon 21.

The adjustment module 14 adjusts the location of the floating icon 21 in response to the adjustment signal. The adjustment module 14 includes a region obtaining unit 141 and an adjustment unit 142.

The region obtaining unit 141 obtains a preference region 25. The preference region 25 is an overlapping area in the second region 23 where a floating icon 21 generally is displayed for a predetermined time. In one embodiment, the region obtaining unit 141 further determines whether there is an overlapping area between the preference region 25 and the second region 23. When no overlapping region is existing between the preference region 25 and the second region 23, the preference region obtaining unit 141 enlarges the preference region 25 until an overlapping region is existing between the enlarged preference region 25 and the second region 23. The preference region 25 and the floating icon are circle regions, and the diameter of the preference region 25 is larger than the diameter of the floating icon 21.

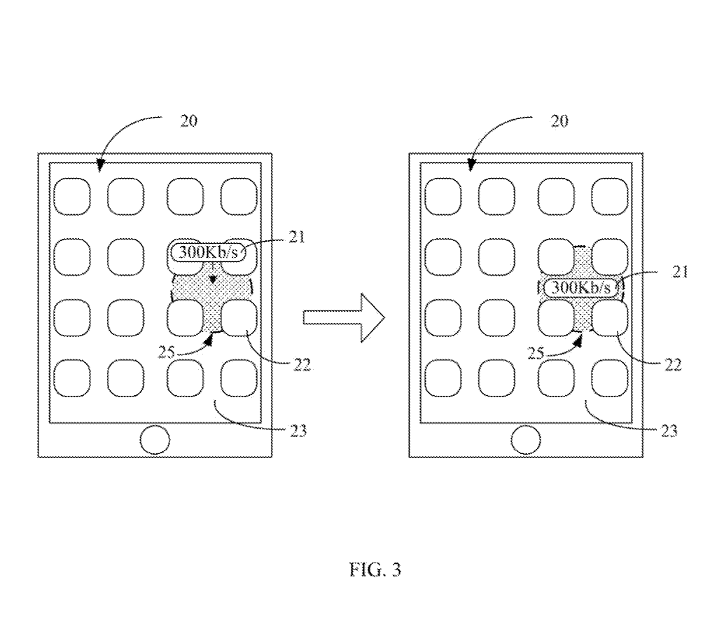

FIG. 3 illustrates embodiments of the electronic device 1 while adjusting the location of the floating icon 21. The adjustment unit 142 adjusts the floating icon 21 to be displayed in the preference region 25 of the user interface 20. The adjustment unit 142 further determines whether the preference region 25 is capable of receiving the floating icon 21. When the preference region 25 is unable to receive the floating icon 21, the adjustment unit 142 adjusts the first region 22 adjacent to the preference region 25 until the preference region is capable of receiving the floating icon 21.

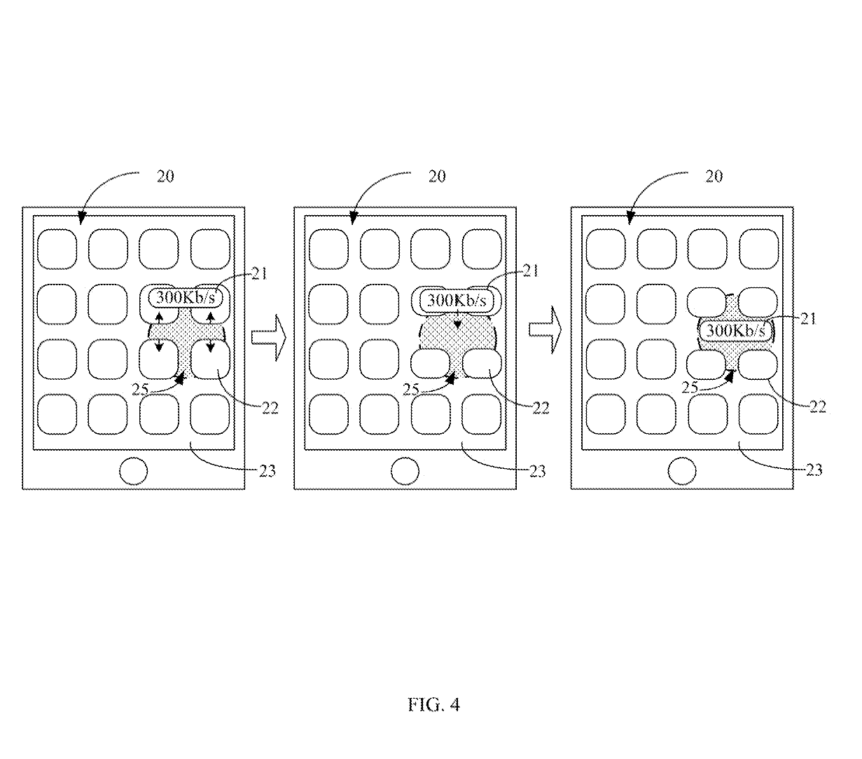

FIG. 4 illustrates one embodiment of the electronic device 1 for adjusting the first region 22 adjacent to the preference region 25 when the preference region 25 is unable to receive the floating icon 21. The adjustment unit 142 reduces the area of the first region 22 until the preference region 25 is able to receive the floating icon 21.

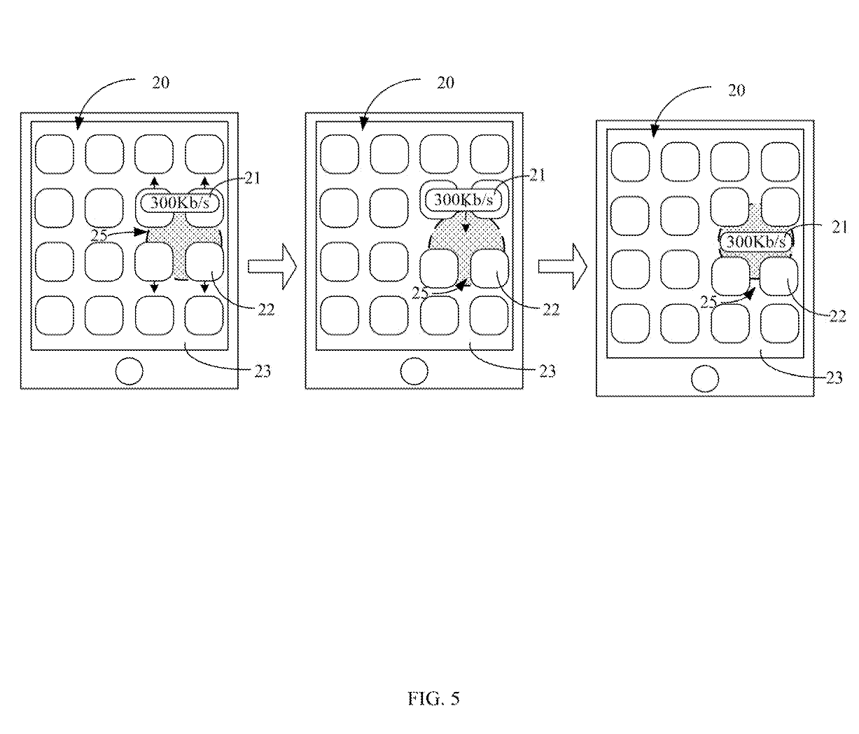

FIG. 5 shows another embodiment of the electronic device 1 for adjusting the first region 22 adjacent to the preference region 25 when the preference region 25 is unable to receive the floating icon 21. The adjustment unit 142 removes the first region 22 in a direction away from the preference region 25 until the preference region 25 is able to receive the floating icon 21.

The storage 20 stores computerized code in the form of one or more programs location information related to the floating icon 21. The storage 20 may be a memory system of the electronic device 1, and may be an external storage card, such as a smart media (SM) card, or secure digital (SD) card, for example.

The processor 30 controls the obtaining module 11, the determining module 12, and the adjustment module 13 to execute a corresponding function.

The display module 50 displays the user interface 20 and the floating icon 21.

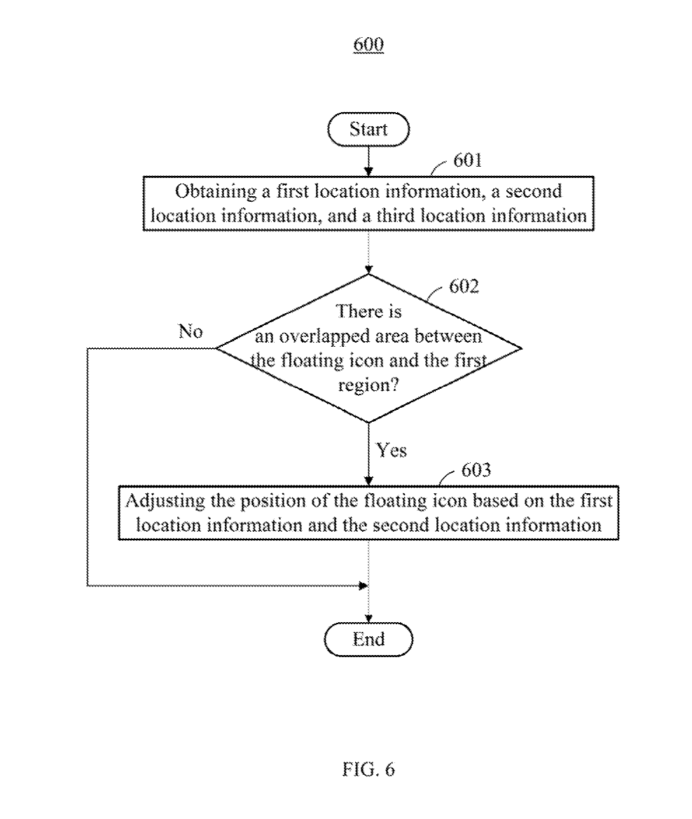

FIG. 6 shows a location adjusting method 300 for adjusting the location of the floating icon 21 on the user interface 20. The method can include the following steps.

In 601, the obtaining module 12 a first location information related to the floating icon 21, a second location information related to the first region 22, and a third location information related to the second region 23 based on the pixel coordinates in response to the trigger signal. The location information is a pixel coordinate assemblage.

In 602, the determining module 13 determines whether there is an overlapping area existing between the first location information and the second location information. If an overlapping area is existing between the first location information and the second location information, an adjustment signal is generated and the procedure goes to 603. If no overlapping area is existing between the first location information and the second location information, the procedure ends.

In 603, the adjustment module 14 adjusts the location of the floating icon 21 on the user interface 20.

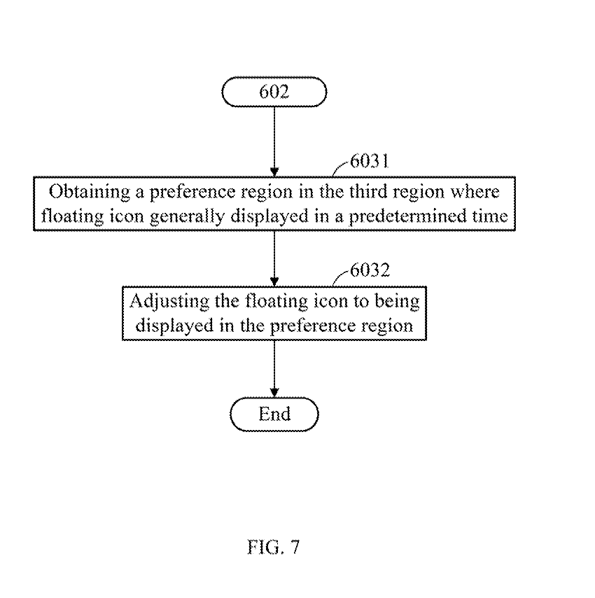

FIG. 7 shows a detail step of adjusting the location of the floating icon 21 on the user interface 20 in FIG. 6. The step 603 further comprises the following steps.

In step 6031, the preference region obtaining unit 141 obtains a preference region 25. The preference region 25 is an overlapping area in the third region 23 where floating icon 21 is generally displayed for a predetermined time. In one embodiment, the preference region obtaining unit 141 further determines whether an overlapping area is between the preference region 25 and the second region 23. When no overlapping area is between the preference region 25 and the second region 23, the preference region obtaining unit 141 enlarges the preference region 25 until an overlapping area is between the enlarged preference region 25 and the second region 23. The preference region 25 and the floating icon are circle regions, and the diameter of the preference region 25 is larger than the diameter of the floating icon 21.

In 6032, the adjustment unit 142 adjusts the floating icon 21 to be displayed in the preference region 25 of the user interface 20.

In use, the floating icon 21 displays in the second region 23 to prevent the contents of the first region 22 from being blocked. Thus, operation convenience increases.

While various embodiments have been described, the disclosure is not to be limited thereto. Various modifications and similar arrangements (as would be apparent to those skilled in the art) are also intended to fall within this disclosure. The scope of the appended claims should be construed to encompass all such modifications and similar arrangements.

What is claimed is:

1. A location adjustment system in an electronic device, the electronic device displaying a floating icon, a first region for displaying contents of applications, and a second region for displaying background picture, the device comprises at least one hardware processor and a storage system to store a contact list and one or more social network applications; the location adjustment system comprises one or more programs, the one or more programs stored in the storage system, executable by the at least one processor, the one or more programs comprising:
an obtaining module for obtaining first location information and second location information;
a determining module for determining whether there is an overlapping area existed between the first location information and the second location information; and
an adjustment module for adjusting the location of the floating icon when there is an overlapping area existed between the first location information and the second location information;
wherein the first location information is related to the floating icon, and the second location information is related to the first region.

2. The location adjustment system of claim 1, wherein the adjustment module further comprises a region obtaining unit and an adjustment unit; the region obtaining unit obtains a preference region; the adjustment unit adjusts the floating icon to be displayed in the preference region.

3. The location adjustment system of claim 2, wherein the obtaining module further obtains third location information; the third location information is related to the second region; the preference region is an overlapping area in the second region where floating icon is generally displayed for a predetermined time.

4. The location adjustment system of claim 2, wherein the region obtaining unit further determines whether there is an overlapping area between the preference region and the second region; when there is no overlapping region between the preference region and the second region, the preference region obtaining unit enlarges the preference region until an overlapping region is existing between the enlarged preference region and the second region.

5. The location adjustment system of claim 2, wherein the adjustment unit further determines whether the preference region is capable of receiving the floating icon; when the preference region is unable to receive the floating icon, the adjustment unit adjusts the first region adjacent to the preference region until the preference region is able to receive the floating icon.

6. The location adjustment system of claim 5, wherein the adjustment unit reduces the area of the first region until the preference region is able to receive the floating icon.

7. The location adjustment system of claim 5, wherein the adjustment unit removes the first region in a direction away from the preference region until the preference region is able to receive the floating icon.

8. A location adjusting method for adjusting location of a floating icon displayed on an electronic device, the electronic device further displaying a first region, and a second region, the location adjusting method comprising:
obtaining first location information and second location information;
determining whether an overlapping area is existing between the first location information and the second location information; and
adjusting the location of the floating icon when an overlapping area is existing between the first location information and the second location information;
wherein the first location information is related to the floating icon, the second location information is related to the first region, and the third location information is related to the second region.

9. The method of claim 8, further comprising:
obtaining a preference region; and
adjusting the location of the floating icon to be displayed in the preference region.

10. The method of claim 8, after the step of obtaining a preference region further comprising:
obtaining a third location information related to the second region;
determining whether an overlapping area is existing between the preference region and the second region; and
enlarging the preference region until there is an overlapping area is existing between the preference region and the second region.

11. The method of claim 9, wherein the preference region is an overlapping area in the second region where floating icon is generally displayed for a predetermined time.

12. The method of claim 8, the step of adjusting the location of the floating icon to be displayed in the preference region further comprising:
determining whether the preference region is capable of receiving the floating icon; and
adjusting the first region adjacent to the preference region until the preference region is able to receive the floating icon.

13. The method of claim 12, further comprising: reducing the area of the first region until the preference region is able to receive the floating icon.

14. The method of claim 12, further comprising: removing the first region in a direction away from the preference region until the preference region is able to receive the floating icon.

15. An electronic device displaying a floating icon, a first region for displaying contents of applications, and a second region for displaying background picture; the electronic device, the electronic device comprising:
an obtaining module for obtaining a first location information and a second location information;
a determining module for determining whether there is an overlapping area existed between the first location information and the second location information; and
an adjustment module for adjusting the location of the floating icon when there is an overlapping area existed between the first location information and the second location information;
wherein the first location information is related to the floating icon, and the second location information is related to the first region.

16. The electronic device of claim 15, wherein the obtaining module further obtains a third location information; the third location information is related to the second region; the adjustment module further comprises a region obtaining unit and an adjustment unit; the region obtaining unit obtains a preference region; the adjustment unit adjusts the floating icon to be displayed in the preference region; the preference region is an overlapping area in the second region where floating icon generally displayed in a predetermined time.

17. The electronic device of claim 16, wherein the region obtaining unit further determines whether an overlapping area is existing between the preference region and the second region; when there is no overlapping region between the preference region and the second region, the preference region obtaining unit enlarges the preference region until an overlapping region is existing between the enlarged preference region and the second region.

18. The electronic device of claim 16, wherein the adjustment unit further determines whether the preference region is capable of receiving the floating icon; when the preference region is unable to receive the floating icon, the adjustment unit adjusts the first region adjacent to the preference region until the preference region is able to receive the floating icon.

19. The electronic device of claim 18, wherein the adjustment unit reduces the area of the first region until the preference region is able to receive the floating icon.

20. The electronic device of claim 18, wherein the adjustment unit removes the first region in a direction away from the preference region until the preference region is able to receive the floating icon.
